(19) United States
(12) Patent Application Publication
(10) Pub. No.: US 2005/0268291 A1
(43) Pub. Date: Dec. 1, 2005

(54) Specifying user interface interactions for controls in a data driven system

(75) Inventor: Scot Alan Aurenz, Nashua, NH (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/140,398

(22) Filed: May 27, 2005

Related U.S. Application Data
(60) Provisional application No. 60/574,896, filed on May 27, 2004.

(51) Int. Cl. G06F 9/45

(52) U.S. Cl. 717/143; 717/115

(57) ABSTRACT

Embodiments of the present invention provide a novel and non-obvious method, system and apparatus for specifying user interface interactions in a data-driven system. In one embodiment, a data-driven data processing system can include a data-driven application including a user interface including one or more controls disposed in the user interface. The system also can include one or more properties configured to accept data input. The system yet further can include markup defining a mapping between the controls and corresponding ones of the properties. Finally, the system can include a markup processor and user interface generation logic including programming to store interactivity with the controls in the corresponding properties.

This patent application claims the benefit under 35 U.S.C. § 119(e) of presently pending U.S. Provisional Patent Application 60/574,896, entitled SPECIFYING INTERACTIONS BETWEEN PROPERTIES IN XML, filed on May 27, 2003, the entire teachings of which are incorporated herein by reference.

### BACKGROUND OF THE INVENTION

1. Field of the Invention

The present invention relates to the field of computer software user interface development and more particularly to graphical user interface controls in a data driven system.

2. Description of the Related Art

The conventional graphical user interface (GUI) has been widely used for many years. The primary function of the GUI includes providing user interface controls with which the end-user can interact with a logic-driven, underlying application. The common GUI includes many stock user interface controls, most of which, when combined, can accommodate most computer-human interactions required by an application. For example, when disposed in a window such as a dialog box, the static text box control can be used to present text to the end-user while an edit box can permit the user to provide textual input to the application. A radio button control can provide for the exclusive selection of an element from among a field of elements, while a checklist box can provide for the non-exclusive selection of elements from among a field of elements.

In traditional, logic-driven systems, interactions with GUI controls are specified by hard code in a programming language, and in that environment it is natural to specify interactions with programming language mechanisms. For example, many GUIs function by using a “listener” design: an object may register to listen to a particular control, and act upon certain events from that control. In such a system, the controls have unique identifiers, such as pointer or resource identifiers, and program code references these identifiers to interact with the controls. Interactions and relationships are managed through the use of traditional code structures such as pointers. These in turn limit flexibility and increase the complexity of managing such relationships within a unit of code.

Data-driven systems differ significantly from logic-driven systems not only in terms of program flow, but also in terms of the user interface generated for the data-driven system. In a data-driven system, unlike a logic-driven system, a set of required functions can be provided to be applied to a set of data. Based upon the provided functions, the data itself can be used to configure the system and to control the application flow in the data-driven system. Data-driven systems have become popular in that the data of the data-driven system can represent real-world entities that when changed, cause changes in logic flow. Additionally, programming a data-driven system often can require little more than configuring a document rather than coding and compiling source code.

Notably, in a data-driven system, the behavior of GUI controls are specified using static markup such as the extensible markup language (XML). Yet, interactions with GUI controls in the data-driven system remains dependent upon hard coded program code or script. Thus, applying even minor design changes to the GUI of a data-driven system can require extensive, manual intervention in the re-coding of the program code or script.

### BRIEF SUMMARY OF THE INVENTION

Embodiments of the present invention address deficiencies of the art in respect to user interface configuration in a data-driven system and provide a novel and non-obvious method, system and apparatus for specifying user interface interactions in a data-driven system. In one embodiment, a data-driven data processing system can include a data-driven application including a user interface including one or more controls disposed in the user interface. The system also can include one or more properties configured to accept data input. The system yet further can include markup defining a mapping between the controls and corresponding properties. Finally, the system can include a markup processor and user interface generation logic including programming to store interactivity with the controls in the corresponding properties.

In another embodiment, a method for specifying user interface interactions for controls disposed in a user interface for a data-driven application can include parsing markup to obtain a reference to a declared property, identifying a mapping between the declared property and one of the controls in the user interface, and storing interactivity with the one of the controls in the declared property. Any property can be mapped to any type of control. Interaction with each control can be defined in terms of the data read and written.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a data-driven data processing system configured to specify user interface interactions for controls in the data-driven data processing system; and,

FIG. 2 is a flow chart illustrating a process for specifying user interface interactions for controls in the data-driven data processing system of FIG. 1.

### DETAILED DESCRIPTION OF THE INVENTION

Embodiments of the present invention provide a method, system and computer program product for specifying user interactions in a user interface for a data-driven application. In accordance with an embodiment of the present invention, properties, controls, actions, and options are referenced by name in markup. Specifically, within the markup, a control can be associated with a property simply by specifying its name. Subsequently, a markup parser can process the markup to map supported GUI controls to corresponding ones of the properties, controls, actions and options specified in the markup. Based upon the mapping, a GUI generator can produce a user interface with controls having the properties mapped by the markup.

Consequently, the markup can specify complex interactions and relationships without the use of traditional code structures such as pointers. Moreover, no identifier or other identity for the control need be used to collect data from a control. Furthermore, the markup reinforces design of GUI as a “facade” between user and data. Finally, the markup enables use of a “data-only” description of the GUI. Accordingly, minor changes to the properties of a control in the GUI do not require an intensive recoding, but an equally minor change to the markup.

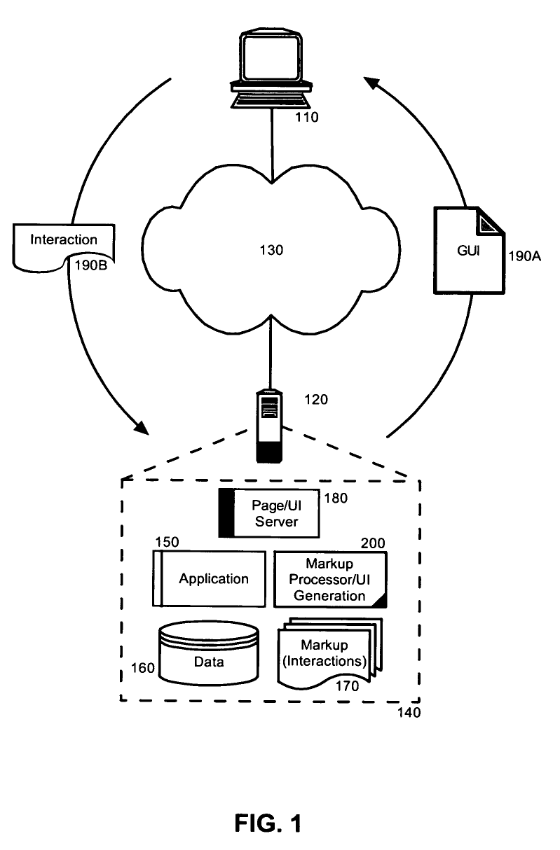

In further illustration, FIG. 1 is a schematic illustration of a data-driven data processing system configured to specify user interface interactions for controls in the data-driven data processing system. The data processing system can include a host platform 120 hosting a data-driven application 140, for example an installation utility for a software configuration management tool. The data-driven application 140 can include application logic 150 providing one or more logic functions which can be invoked responsive to changes in data 160. The data-driven application 140 also can include a user interface server logic 180 configured to render a user interface to the data-driven application 140.

Optionally, the data-driven application 140 can be configured for use by one or more communicatively coupled clients 110 over a data communications network 130. In this circumstance, the user interface server logic 180 can be configured to render a user interface to the driven application 140 by serving markup language pages to content browsers in the communicatively coupled clients 110. The markup language pages can form a user interface 190A to the data-driven application 140 and interactivity 190B with the user interface 190B can be captured and processed in the data-driven application 140.

In accordance with the illustrative embodiment of the invention, the data-driven application 140 can include a markup processor and user interface generation logic 200. The markup processor and user interface generation logic 200 can be programmed to parse markup 170 specifying user interface interactions for controls in a user interface for the data driven application 140. In this regard, the markup 170 can declare one or more properties—essentially a container configured to hold one or more strings. The markup 170 further can include a mapping of individual user interface controls to corresponding individual ones of the declared properties.

As an example, the markup 170 can take the following form:

-----------------------------------------------------------------------------

Property Interaction:
Examples of Interchangeable GUI controls

-----------------------------------------------------------------------------

<!--

The <property> element declares a property.
This gives the property a name, and perhaps some
attributes.
A property doesn't really have a “type”; It can
be thought of as
a general-purpose container capable of holding one or
more strings.

-->
<property name=“PROPERTY_1”/>
<property name=“PROPERTY_2”/>

...

<property name=“PROPERTY_n”/>
<!--

The <page> element declares a page in the wizard sequence.
A page contains text and controls for gathering one or
more properties.

-->

<page title=“TITLE” help=“HELP ”>

<!--

A property can be mapped to any kind of GUI control.
Of course, different GUI controls have different input
capabilities,
but any property is capable of storing input from any
GUI control.

-->
<label title=“LABEL_1”/>
<!--

Here, a combo box control is used to present choices
to the user.
The selected choice will be written into the
PROPERTY_1 property.

-->
<combo property=“PROPERTY_1”/>
<label title=“LABEL_2”/>
<!--

Here, an edit control is used so the user can enter a string.
The string will be written to the PROPERTY_2 property.

-->
<edit property=“PROPERTY_2”/>

...

<label title=“LABEL_N”/>
<!--

Here, a checkbox control is used so the user can select
from a discrete
set of entries. The entries will be written as a set of
string fragments
to the PROPERTY_N property.

-->
<checkbox property=“PROPERTY_N”/>

</page>

In operation, the markup processor and user interface generation logic 200 can obtain a reference for each declared property in the markup 170. The markup processor and user interface generation logic 200 can produce a user interface 190A and, as controls are declared in the markup 170 for the user interface 190A, corresponding controls can be included in the user interface 190A. Subsequently, interactivity 190B with the controls, such as data entry for each control in the user interface 190A can be stored in the property that was mapped to the control. In this way, linking declared properties with a control type is as simple as declaring the mapping in the markup 170. Moreover, changing the linkage from one control type to another control can be as simple as editing the mapping for the linkage in the markup.

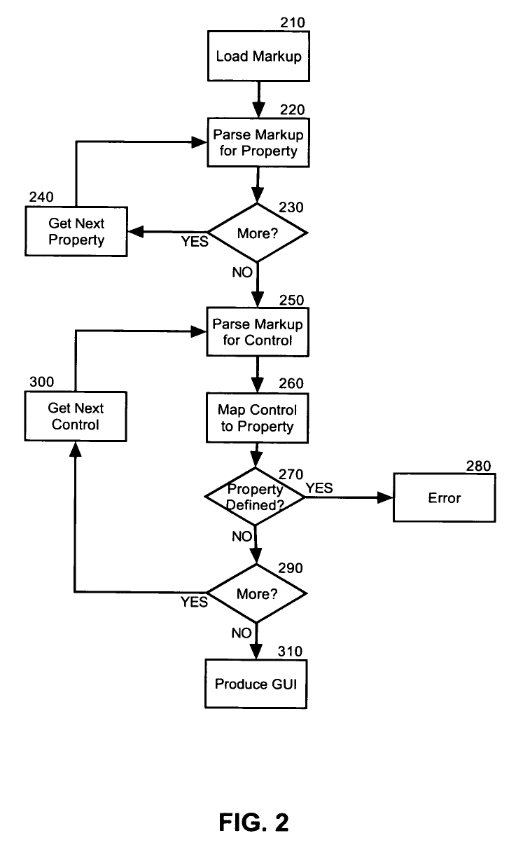

In further illustration of the operation of the markup processor and user interface generation logic 200, FIG. 2 is a flow chart illustrating a process for specifying user interface interactions for controls in the data-driven data processing system of FIG. 1. Beginning in block 210, markup can be loaded for the data-driven application. In block 220, the markup can be parsed to identify declared properties. In block 230, if additional properties can be identified for declared properties in the markup, in block 240 the next property can be retrieved and the process can continue until all declared properties have been identified in the markup.

In block 250, the markup can be parsed for controls and a first control specified for the user interface for the data-driven application can be obtained. In block 260, the obtained control can be mapped to a corresponding property. If the property had not been previously defined in decision block 270, an error condition can arise in block 280. Otherwise, in decision block 290, if additional controls can be obtained in the markup, in block 300 a next control can be obtained and the process can repeat until no additional controls remain to be processed. When no further controls remain to be processed in decision block 290, in block 310 the user interface for the data-driven application can be produced and provided for rendering.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

1. A data-driven data processing system comprising:
a data-driven application comprising a user interface comprising a plurality of controls disposed in said user interface;
a plurality of properties configured to accept data input;
markup defining a mapping between said controls and corresponding ones of said properties; and,
markup processor and user interface generation logic comprising programming to store interactivity with said controls in said corresponding ones of said properties.

2. The system of claim 1, wherein each of said controls comprises a control selected from the group consisting of an edit field, a checkbox, a checklist control, a radio button group, a push button control, a tree control and a combo box.

3. The system of claim 1, wherein each of said properties comprises a container configured to store string data.

4. The system of claim 1, wherein said user interface comprises at least one markup language page.

5. The system of claim 1, wherein said data-driven application comprises a software configuration tool for a software installation system.

6. A method for specifying user interface interactions for controls disposed in a user interface for a data-driven application, the method comprising:
parsing markup to obtain a reference to a declared property;
identifying a mapping between said declared property and one of the controls in the user interface; and,
storing interactivity with said one of the controls in said declared property.

7. The method of claim 6, further comprising:
changing said mapping to specify a different control for said declared property; and,
storing interactivity with said different control in said declared property.

8. The method of claim 6, further comprising generating the user interface to incorporate said mapping.

9. The method of claim 6, wherein each of the controls comprises a control selected from the group consisting of an edit field, a checkbox, a checklist control, a radio button group, a push button control, a tree control and a combo box.

10. The method of claim 6, wherein said declared property comprises a container configured to store string data.

11. The method of claim 6, wherein the user interface comprises at least one markup language page.

12. The method of claim 6, wherein the data-driven application comprises a software configuration tool for a software installation system.

13. A computer program product comprising a computer usable medium including computer usable program code for specifying user interface interactions for controls disposed in a user interface for a data-driven application, said computer program product including:
computer usable program code for parsing markup to obtain a reference to a declared property;
computer usable program code for identifying a mapping between said declared property and one of the controls in the user interface; and,
computer usable program code for storing interactivity with said one of the controls in said declared property.

14. The computer program product of claim 13, further comprising:
computer usable program code for changing said mapping to specify a different control for said declared property; and,
computer usable program code for storing interactivity with said different control in said declared property.

15. The computer program product of claim 13, further comprising computer usable program code for generating the user interface to incorporate said mapping.

16. The computer program product of claim 13, wherein each of the controls comprises a control selected from the group consisting of an edit field, a checkbox, a checklist control, a radio button group, a push button control, a tree control and a combo box.

17. The computer program product of claim 13, wherein said declared property comprises a container configured to store string data.

18. The computer program product of claim 13, wherein the user interface comprises at least one markup language page.

19. The computer program product of claim 13, wherein the data-driven application comprises a software configuration tool for a software installation system.
